(19) United States
(12) Patent Application Publication
(10) Pub. No.: US 2012/0031892 A1
(43) Pub. Date: Feb. 9, 2012

(54) Heat Treatment Method, Recording Medium Having Recorded Program for Executing Heat Treatment Method, and Heat Treatment Apparatus

(75) Inventors: Kenichi Shigetomi, Koshi-City (JP); Jun Ookura, Koshi-City (JP)

(73) Assignee: Tokyo Electron Limited

(21) Appl. No.: 13/192,635

(22) Filed: Jul. 28, 2011

(30) Foreign Application Priority Data
Aug. 9, 2010 (JP) 2010-178854

(51) Int. Cl. H05B 3/68

(52) U.S. Cl. 219/444.1

(57) ABSTRACT

Disclosed is a method of a thermal processing including a first process and a second process. The first process between first wafer (initial wafer) W1 and second wafer (next wafer) W2 (and subsequent wafers W), comprises changing a set temperature of a heating plate from a first temperature to a second temperature which is lower than the first temperature; and initiating a thermal processing for a first substrate before the temperature of the heating plate reaches the second temperature. The second process comprises changing the set temperature of the heating plate from the second temperature to a third temperature which is higher than the second temperature, after the first process for the first substrate is completed; and initiating a thermal processing for a second substrate when the temperature of the heating plate is changed from the third temperature to the second temperature after the temperature of the heating plate reached the third temperature.

### CROSS-REFERENCE TO RELATED APPLICATIONS

This application is based on and claims priority from Japanese Patent Application No. 2010-178854 filed on Aug. 9, 2010 with the Japanese Patent Office, the disclosure of which is incorporated herein in its entirety by reference.

### TECHNICAL FIELD

The present disclosure relates to a method for a heat treatment (e.g., a thermal processing) of a substrate, a computer-readable recording medium storing program for executing the method, and an apparatus for the thermal processing.

### BACKGROUND

In a manufacturing process of integrated circuits of semiconductor devices, a coating and developing processing employing a photolithography technique is performed to form a resist pattern on a surface of a semiconductor wafer or LCD substrate or the like (hereinafter referred to as “wafer”). The coating and developing processing employing a photolithography technique includes a resist coating process applying a resist liquid on the surface of the wafer, an exposing process exposing a circuit pattern to be transferred on the formed resist film, and a developing process supplying the wafer having been subjected to exposing processing with developing liquid.

Further, various types of thermal processing are performed in the coating and developing processing employing a photolithography technique.

For example, a thermal processing (a pre-baking process) that evaporates residual solvent in the resist film to improve adhesion of the wafer and the resist film is performed between the resist coating process and the exposing process. Further, a thermal processing (a baking after exposure process (PEB; Post Exposure Baking)) that induces an acid catalyzed reaction in chemically amplified resist (CAR) is performed between the exposing process and the developing process. Still further, a thermal processing (a post baking process) is performed after the developing process to remove the residual solvent in the resist film or a rinse liquid flowed into the resist during the developing processing for preventing the infiltration of the residual solvent and rinse liquid during wet etching.

The condition of the respective thermal processing described above may be strictly regulated to manage the critical dimension CD of the resist pattern to be formed. In particular, in a case where chemically amplified resist (CAR) that has received a wide attention recently due to its capability of accomplishing a high sensitivity, a high resolution and a high resistance over the dry etching is used as a resist, the condition of the thermal processing of the post-exposure baking process may be strictly regulated because the difference in the heat quantity being supplied to the resist film at the respective sites within a surface of the substrate has a severe effect on dimension precision of the circuit pattern in the integrated circuits of semiconductor devices to be manufactured.

Japanese Patent Laid-Open Publication No. 2003-51439 discloses a thermal processing method and a thermal processing apparatus in which, in order to manage the condition of the thermal processing, the output amount of heat source is controlled to make the heat quantity being supplied to the substrate during the thermal processing to be the same at a plurality of sites on the substrate.

### SUMMARY

According to an exemplary embodiment of the present disclosure, there is provided a method of a thermal processing of a substrate group including a plurality of substrates in which each of substrates of the substrate group is sequentially processed thermally by disposing each of substrate on a heating plate to be set to a predetermined temperature, the method comprising: a first process which comprises changing a set temperature of the heating plate from a first temperature to a second temperature which is lower than the first temperature; initiating a thermal processing for a first substrate of the substrate group before the temperature of the heating plate reaches the second temperature; and continuing the thermal processing for the first substrate while the temperature of the heating plate is being maintained at the second temperature. The method further comprises a second process which includes: changing the set temperature of the heating plate from the second temperature to a third temperature which is higher than the second temperature after the first process for the first substrate is completed; initiating a thermal processing for a second substrate of the substrate group which is a next substrate to the first substrate in the substrate group when the set temperature of the heating plate is changed to the second temperature after the temperature of the heating plate reached the third temperature; and continuing the thermal processing for the second substrate while the temperature of the heating plate is being maintained at the second temperature.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a plan view illustrating a schematic configuration of a coating and developing processing system according to an exemplary embodiment of the present disclosure.

FIG. 2 is a front view illustrating a schematic configuration of the coating and developing processing system according to an exemplary embodiment of the present disclosure.

FIG. 3 is a rear view illustrating a schematic configuration of the coating and developing processing system according to an exemplary embodiment of the present disclosure.

FIG. 4 is a longitudinal cross-sectional view illustrating a schematic configuration of a post-exposure baking apparatus according to an exemplary embodiment of the present disclosure.

FIG. 5 is a transverse cross-sectional view illustrating a schematic configuration of the post-exposure baking apparatus according to an exemplary embodiment of the present disclosure.

FIG. 6 is an enlarged plan view illustrating a heating plate.

FIG. 7 is a longitudinal cross-sectional view taken along the line A-A of FIG. 6.

FIG. 8 is a longitudinal cross-sectional view illustrating a schematic configuration of a critical dimension measuring apparatus.

FIG. 9 is a flow chart explaining the sequence of a thermal processing method according to an exemplary embodiment of the present disclosure.

FIG. 10 is a graph plotting the change in a heating plate temperature over a time period at steps S11 and S12.

FIG. 11 is a graph plotting the change of wafer temperature of the test wafer over time at steps S11 and S12.

FIG. 12 is a cross-sectional view schematically illustrating a resist pattern formed by performing a post-exposure baking process according to the same thermal processing conditions as those of the respective steps S11 and S12 after exposing, and a developing process.

FIG. 13 is a graph comparatively plotting the critical dimensions of the resist pattern having been subjected to a post-exposure baking process according to the same thermal processing conditions as those of the respective steps S11 and S12.

FIG. 14 is a graph plotting the change in the heating plate temperature over a time period at steps S16 and S17.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

Following problems generally exist in the above-described thermal processing method and thermal processing apparatus.

For example, when a substrate to which a plurality of different types of resist film each requiring a different thermal processing temperature are applied is subjected to a continuous and sequential thermal processing in a post-exposure baking process, the temperature of the heating plate needs to be changed rapidly.

A thermal processing apparatus typically includes a heating plate and a substrate is disposed on the heating plate set to a predetermined temperature to perform the thermal processing for the substrate. The heating plate typically utilizes a heater as a heat source which generates heat through a current conduction. Therefore, when the set temperature of the heating plate is changed from a low temperature to a high temperature, the temperature of the heating plate increases rapidly due to the current conduction to the heater, and thus the temperature of the heating plate can be changed in a relatively high speed.

However, a thermal processing apparatus generally does not have a cooling mechanism to cool down a heating plate. Therefore, when the set temperature of the heating plate is changed from a high temperature to a low temperature, the heating plate is cooled naturally in most cases and thus it cannot be cooled rapidly. Accordingly, the initiation of the thermal processing of a first substrate needs to be delayed until the temperature of the heating plate reaches the set temperature, after the set temperature of the heating plate changed from a high temperature to a low temperature. Therefore, a processing time of the substrate cannot be shortened and thus manufacturing cost cannot be reduced.

Meanwhile, when a thermal processing of a first substrate is initiated before the temperature of the heating plate reaches the set temperature, the temperature history of the first substrate is different from that of a next substrate for which the thermal processing is initiated in a state where the temperature of the heating plate is maintained at the set temperature, after a thermal processing of the first substrate is completed. Therefore, the characteristics of the coating film, such as a resist film vary between the substrates when a plurality of substrates are processed. In particular, when the thermal processing is a post-exposure baking, the critical dimension CD of the resist pattern varies between the substrates, which is problematic.

When the set temperature of the heating plate is changed from a high temperature to a low temperature, either a method for making the capacity of the heating plate to be smaller, or a method for installing in the vicinity of the heating plate a cooling mechanism such as a cooling gas nozzle spraying the cooling gas over the heating plate may be conceived so as to rapidly cool down the heating plate. However, the method for making the capacity of the heating plate to be smaller has a problem in that the strength and performance of the heating plate decrease as the heating plate becomes miniaturized and thinner. Further, the method for providing a cooling mechanism in the vicinity of the heating plate has a problem in that manufacturing cost of the thermal processing apparatus increases.

The present disclosure has been made in consideration of the problems described above to provide a thermal processing method and a thermal processing apparatus in which the processing time of the substrates can be shortened while preventing the characteristics of coated films between substrates from being varied, without decreasing the strength of the heating plate or increasing manufacturing cost of the apparatus.

The present disclosure provides following means necessary for solving the problems described above.

An exemplary embodiment of the present disclosure provides a method of a thermal processing of a substrate group including a plurality of substrates in which each of substrates of the substrate group is sequentially processed thermally by disposing each of substrates on a heating plate to be set to a predetermined temperature, the method comprising a first process which comprises changing a set temperature of the heating plate from a first temperature to a second temperature which is lower than the first temperature, initiating a thermal processing for a first substrate of the substrate group before the temperature of the heating plate reaches the second temperature, and continuing the thermal processing for the first substrate while the temperature of the heating plate is being maintained at the second temperature. The method further comprises a second process which comprises changing the set temperature of the heating plate from the second temperature to a third temperature which is higher than the second temperature, after the first process for the first substrate is completed, initiating a thermal processing for a second substrate of the substrate group which is a next substrate to the first substrate in the substrate group when the set temperature of the heating plate is changed to the second temperature after the temperature of the heating plate reached the third temperature, and continuing the thermal processing for the second substrate while the temperature of the heating plate is being maintained at the second temperature.

The method of a thermal processing further includes a first data obtaining process which comprises changing the set temperature of the heating plate from the first temperature to the second temperature, initiating a thermal processing for a first test substrate before the temperature of the heating plate reaches the second temperature, and obtaining temperature data for the first test substrate or the heating plate while the thermal processing is being performed for the first test substrate. The method further includes a determining process determining the third temperature based on the temperature data for the first test substrate or the heating plate. Further, the determining process determines the third temperature to be higher than the temperature at which the thermal processing for the first substrate is initiated.

Further, the method of a thermal processing further includes a second data obtaining process comprising changing the set temperature of the heating plate to the third temperature after determining the third temperature, initiating a thermal processing for a second test substrate by the heating plate when the set temperature of the heating plate is changed to the second temperature, after the temperature of the heating plate reached the third temperature, and obtaining temperature data for the second test substrate while the thermal processing is being performed for the second test substrate. Further, the method further includes connecting the temperature at which the thermal processing for the first substrate is initiated based on the temperature data for the second test substrate. Further, in the method described above, the temperature at which the thermal processing for the first substrate is initiated is determined based on a heat capacity of the first substrate.

Still further, the present disclosure provides a non-transitory computer-readable recording medium storing a computer executable program that, when executed, causes a computer to perform the method of the thermal processing as described above.

An exemplary embodiment of the present disclosure provides a thermal processing apparatus comprising a heating plate configured to be set to a predetermined temperature and dispose each of substrates of a substrate group including a plurality of substrates thereby sequentially performing a thermal processing for the plurality of substrates, and a control unit configured to control an overall operation of the thermal processing apparatus. In the thermal processing apparatus, the control unit changes a set temperature of the heating plate from a first temperature to a second temperature which is lower than the first temperature, initiates a thermal processing for a first substrate of the substrate group before the temperature of the heating plate reaches the second temperature, continues the thermal processing for the first substrate while the temperature of the heating plate is being maintained at the second temperature, changes the set temperature of the heating plate from the second temperature to a third temperature which is higher than the second temperature after the thermal processing for the first substrate is completed, initiates a thermal processing for a second substrate of the substrate group which is a next substrate to the first substrate in the substrate group when the set temperature of the heating plate is changed to the second temperature after the temperature of the heating plate reached the third temperature, and continues the thermal processing for the second substrate while the temperature of the heating plate is being maintained at the second temperature.

In the thermal processing apparatus, the control unit changes the set temperature of the heating plate from the first temperature to the second temperature, initiates a thermal processing for a first test substrate before the temperature of the heating plate reaches the second temperature, obtains temperature data for the first test substrate or the heating plate while the thermal processing is being performed for the first test substrate, and determines the third temperature based on the temperature data for the first test substrate or the heating plate. In this case, the control unit may determine the third temperature to be higher than the temperature at which the thermal processing for the first substrate is initiated.

In the thermal processing apparatus, the control unit changes the set temperature of the heating plate to the third temperature after determining the third temperature, initiates a thermal processing for a second test substrate by the heating plate when the set temperature of the heating plate is changed to the second temperature after the temperature of the heating plate reached the third temperature, obtains temperature data for the second test substrate while the thermal processing is being performed for the second test substrate, and corrects temperature at which the thermal processing for the first substrate is initiated based on the temperature data for the second test substrate. Further, the temperature at which the thermal processing for the first substrate is initiated is determined based on a heat capacity of the first substrate.

According to the exemplary embodiments of the present disclosure, a time for processing substrates can be shortened while preventing the characteristic of coated films between substrates from being varied, without decreasing the strength of the heating plate or increasing manufacturing cost of the apparatus.

Next, exemplary embodiments of the present disclosure will be described with reference to the accompanying drawings.

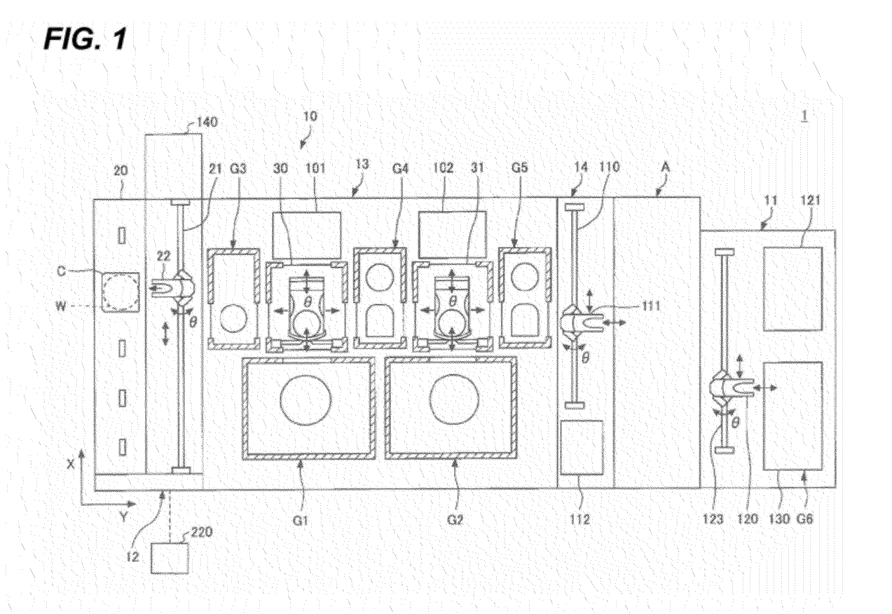

Hereinafter, a coating and developing system including a thermal processing apparatus according to the exemplary embodiment of the present disclosure will be described with reference to FIGS. 1 to 8.

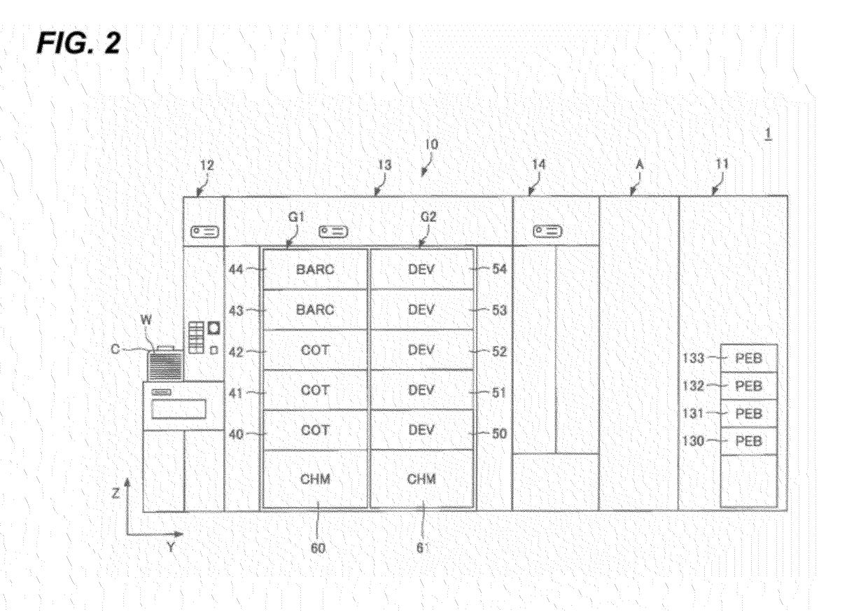

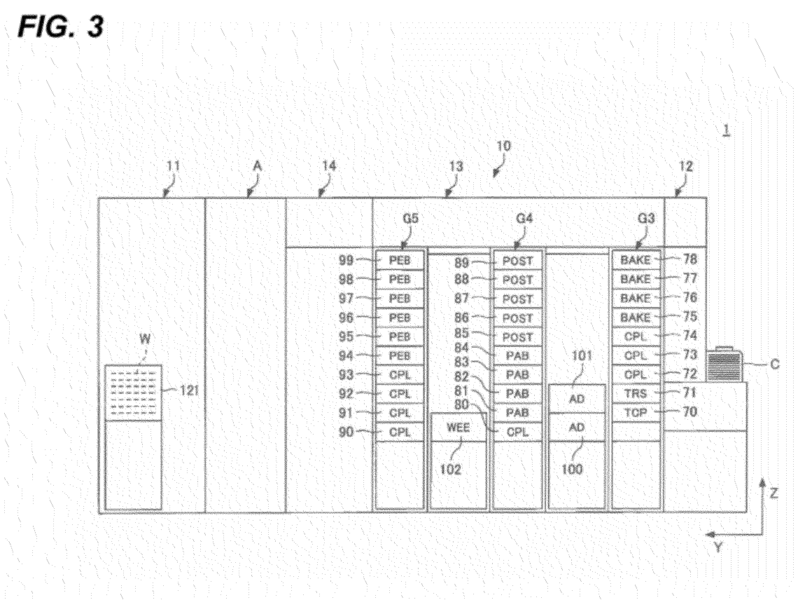

The coating and developing system of the present disclosure will be described with reference to FIGS. 1 to 3. FIG. 1 is a plan view illustrating a schematic configuration of coating and developing system according to an exemplary embodiment of the present disclosure. FIG. 2 is a front view illustrating a schematic configuration of the coating and developing system. FIG. 3 is a rear view illustrating a schematic configuration of the coating and developing system.

A coating and developing system 1 includes a first processing system 10 and a second processing system 11 provided at both sides of an exposing apparatus A, as shown in FIG. 1. First processing system 10 is, for example, configured to be connected integrally with a cassette station 12, a processing station 13 and an interface station 14. Cassette station 12 carries in and carries out twenty-five (25) sheets of wafer W by a cassette C for coating and developing system 1 from outside, or carries in and carries out wafer W for cassette C. Processing station 13 is a processing unit in which various types of processing apparatuses each performing a predetermined processing for each sheet of wafer in a photolithographic process are disposed in a multi-stage configuration. Interface station 14 is a transfer unit delivering wafer W to exposure apparatus A. Cassette station 12, processing station 13 and interface station 14 are disposed in order toward the positive side of Y direction (right direction in FIG. 1), and interface station 14 is connected with exposing apparatus A.

A cassette placing table 20, provided in cassette station 12, is configured such that a plurality of cassettes C can be disposed in a line along the X direction (up/down direction in FIG. 1). A transfer device 22 movable along a transfer path 21 in the X direction is provided in cassette station 12. Transfer device 22 is also movable to the wafer arrangement direction of wafers W (Z direction; a vertical direction) accommodated in cassette C to selectively access wafers W disposed in an up/down direction within cassette C. Transfer device 22 is rotatable around the vertical axis (8 direction) to selectively access the respective apparatuses of a third processing apparatus group G3 at processing station 13 side. Third processing apparatus group G3 will be described below.

Processing station 13 includes, for example, five (5) processing apparatus groups G1 to G5 having a plurality of processing apparatuses disposed in a multi-stage configuration. A first processing apparatus group G1 and a second processing apparatus group G2 are disposed in order from cassette station 12 side, at a negative side of X direction (downward direction in FIG. 1) of processing station 13. Third processing apparatus group G3, a fourth processing apparatus group G4 and a fifth processing apparatus group G5 are disposed in order from cassette station 12 side, at a positive side of X direction (upward direction in FIG. 1) of processing station 13. A first transfer apparatus 30 is provided between third processing apparatus group G3 and fourth processing apparatus group G4. First transfer apparatus 30 is configured to selectively access the respective apparatuses within first processing apparatus group G1, third processing apparatus group G3 and fourth processing apparatus group G4 to transfer wafer W. A second transfer apparatus 31 is provided between fourth processing apparatus group G4 and fifth processing apparatus group G5 and configured to selectively access the respective apparatuses within second processing apparatus group G2, fourth processing apparatus group G4 and fifth processing apparatus group G5 to transfer wafer W.

As shown in FIG. 2, in first processing apparatus group G1, liquid processing apparatuses such as resist coating apparatuses (COT) 40, 41 and 42 and bottom anti-reflection coating apparatuses (BARC) 43 and 44 performing liquid processing by supplying a predetermined liquid to wafer W are stacked with a five (5) stage configuration in sequence from the bottom. Resist coating apparatuses (COT) 40, 41 and 42 apply resist liquid on wafer W to form a resist film. Bottom coating apparatuses (BARC) 43 and 44 form an anti-reflecting film preventing reflection of light caused by exposure. In second processing apparatus group G2, liquid processing apparatuses such as developing processing apparatuses (DEV) 50 to 54 performing developing process by supplying developing liquid to wafer W are stacked with a five (5) stage configuration in sequence from the bottom. Further, chemical chambers (CHM) 60 and 61 are provided at the lowermost stages of processing apparatus groups G1 and G2, respectively, for supplying various kinds of processing liquids to the liquid processing apparatuses within each of processing apparatus groups G1 and G2.

For example, as shown in FIG. 3, in third processing apparatus group G3, temperature control apparatus (TCP) 70, transition apparatus (TRS) 71, high-precision temperature control apparatuses (CPL) 72 to 74 and thermal processing apparatuses (BAKE) 75 to 78 are stacked with a nine (9) stage configuration in sequence from the bottom. Transition apparatus 71 delivers wafer W, high-precision temperature control apparatuses (CPL) 72 to 74 adjust temperature of wafer W under a high-precision temperature control, and thermal processing apparatuses 75 to 78 perform a thermal processing for wafer W.

In fourth processing apparatus group G4, high-precision temperature control apparatus (CPL) 80, pre-baking apparatuses (PAB) 81 to 84 and post baking apparatuses (POST) 85 to 89 are stacked with a ten (10) stage configuration in sequence from the bottom. Pre-baking apparatuses 81 to 84 perform a thermal processing for wafers W with the coating process has been completed. Post baking apparatuses (POST) 85 to 89 perform a thermal processing for wafers W with the developing process has been completed.

In fifth processing apparatus group G5, a plurality of apparatuses performing a thermal processing for wafers W, for example, high-precision temperature control apparatuses (CPL) 90 to 93 and post-exposure baking apparatuses (PEB) 94 to 99 as thermal processing apparatus are stacked with a ten (10) stage configuration in sequence from the bottom.

As shown in FIG. 1, a plurality of processing apparatuses are disposed in a positive side of X direction (upward direction in FIG. 1) of first transfer apparatus 30. As shown in FIG. 3, adhesion apparatuses (AD) 100 and 101 are stacked with a two (2) stage configuration in sequence from the bottom for hydrophobizing wafers W appropriate for processing. As shown in FIG. 1, a periphery exposure apparatus (WEE) 102 selectively exposing the edge portion of wafer W only is disposed in a positive side of X direction.

For example, as shown in FIG. 1, a wafer transfer unit 111 moving on a transfer path 110 extended and elongated toward the X direction and a buffer cassette 112 are provided in interface station 14. Wafer transfer unit 111 is movable in the Z direction and also rotatable in the 8 direction, and is configured to access exposing apparatus A adjacent to interface station 14, buffer cassette 112 and the respective apparatuses within fifth processing apparatus group G5 to transfer wafer W.

In second processing system 11, a wafer transfer apparatus 120 serving as a transfer apparatus, a sixth processing apparatus group G6 and buffer cassette 111 serving as an accommodating unit are provided. Wafer transfer apparatus 120 is movable on a transfer path 123 provided at exposure apparatus A side and extended in the X direction. Wafer transfer apparatus 120 is movable in the Z direction and also rotatable in the θ direction, and is configured to access exposing apparatus A, sixth processing apparatus group G6 and a buffer cassette 121 to transfer wafer W. Wafer transfer apparatus 120 has an alignment function adjusting the position of wafer W.

Sixth processing apparatus group G6 and buffer cassette 121 are arranged and provided in the X direction at the positive side of Y direction of transfer path 123. In sixth processing apparatus group G6, post-exposure baking apparatuses (PEB) 130 to 133 serving as a thermal processing apparatus are stacked with a four (4) stage configuration in sequence from the bottom, as shown in FIG. 2. Buffer cassette 121 is configured to temporarily accommodate multiple sheets of wafers W (See, e.g., FIG. 3).

Further, as shown in FIG. 1, cassette station 12 is provided with a critical dimension measuring apparatus 140 measuring the critical dimension of the resist pattern on wafer W.

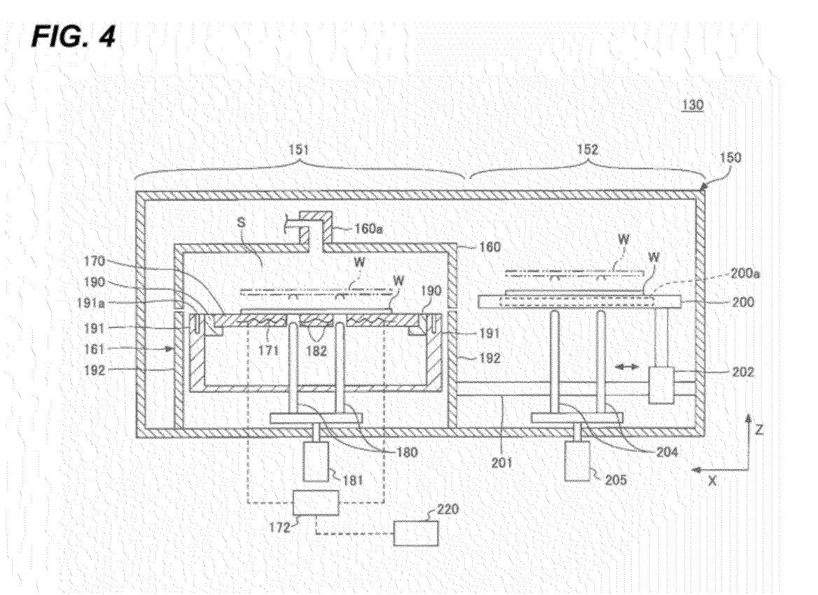

Next, the post-exposure baking apparatus corresponding to the thermal processing apparatus in the exemplary embodiment of the present disclosure will be described with reference to FIGS. 4 to 7.

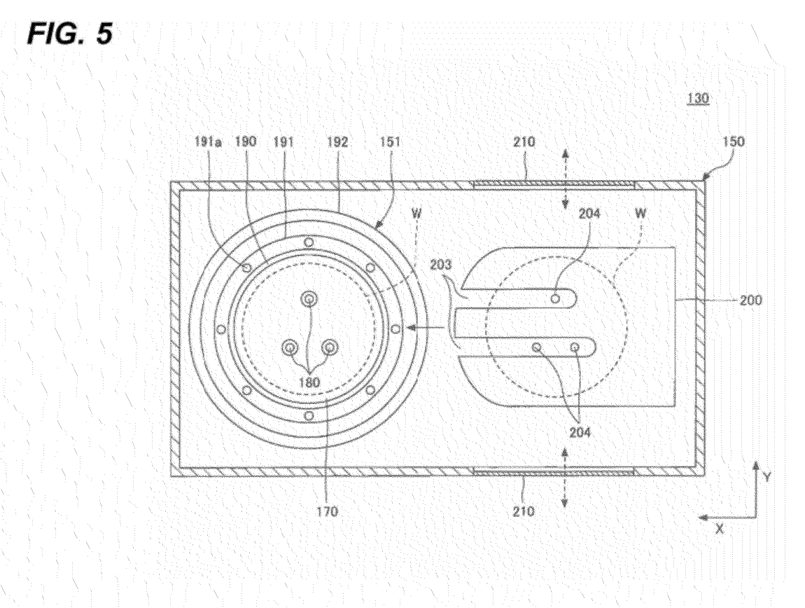

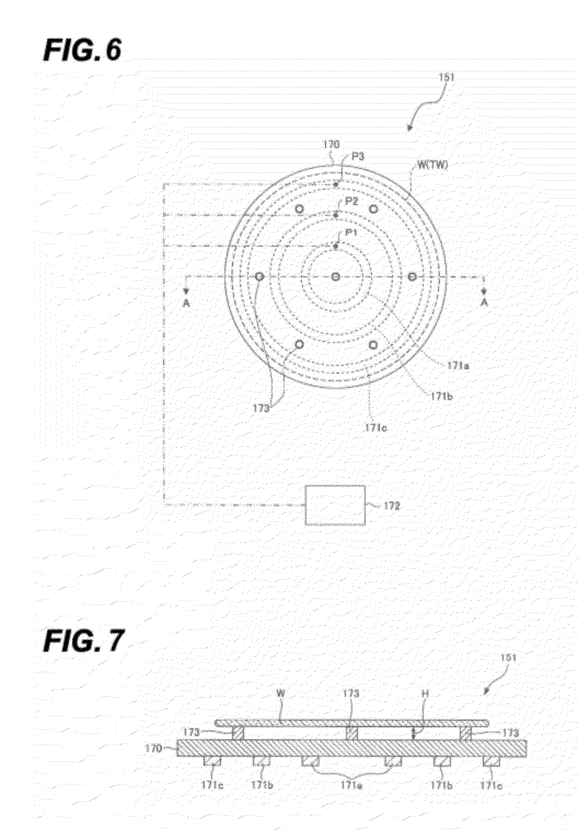

FIG. 4 is a longitudinal cross-sectional view illustrating a schematic configuration of the post-exposure baking apparatus according to an exemplary embodiment of the present disclosure. FIG. 5 is a transverse cross-sectional view illustrating a schematic configuration of the post-exposure baking apparatus according to an exemplary embodiment of the present disclosure. FIG. 6 is an enlarged plan view illustrating a heating plate. FIG. 7 is a longitudinal cross-sectional view taken along the line A-A of FIG. 6. For the convenience of illustration, a first elevating pin and a through-hole or the like are omitted in FIGS. 6 and 7.

As shown in FIGS. 4 and 5, a post-exposure baking apparatus 130 includes a heating unit 151 and a cooling unit 152 heating and cooling wafer W, respectively, in a casing 150.

As shown in FIG. 4, heating unit 151 includes a cover 160 located at an upper side thereof and movable up and down, and a heating plate accommodating unit 161 located at a lower side thereof to form a processing chamber S integrally with cover 160.

An exhausting portion 160a is provided at the center of the ceiling part of cover 160 and configured to uniformly exhaust atmosphere within processing chamber S from exhausting portion 160a.

A heating plate 170 in which wafer W is disposed and heated is provided at the center of heating plate accommodating unit 161. Heating plate 170 is formed as a substantially disk-shape which is larger than wafer W and has a thickness. A heater 171 is incorporated in heating plate 170 generating heat by supplying an electric current. A heat quantity to be generated is adjusted, for example, by a heater control apparatus 172. A temperature control is performed, for example, by a main body control unit 220 which will be describe herein below.

Heater control apparatus 172 and main body control unit 220 correspond to a control unit in the exemplary embodiment of the present disclosure.

As shown in FIGS. 6 and 7, heater 171 is composed of a plurality of heaters 171a to 171c arranged in concentric circles at an appropriate interval and, as described above, incorporated in heating plate 170. Further, each of heaters 171a to 171c is connected with heater control apparatus 172 independently.

In FIG. 6, heater 171 is composed of three (3) heaters 171a to 171c, but may also be composed of a plurality of heaters without being limited to three heaters.

A plurality of temperature sensors (not shown) are provided at a plurality of positions P1, P2 and P3 in heating plate 170 corresponding to the respective heaters 171a to 171c to independently control the respective heaters 171a to 171c, such that heating plate temperature PV can be measured by the respective temperature sensors. Further, heating plate temperature PV measured by respective temperature sensors is inputted to heater control apparatus 172 which is configured to control output of the respective heaters 171a to 171c based on the difference between heating plate temperature PV and a set temperature.

As shown in FIGS. 6 and 7, gap pins 173 supporting wafer W to be separated from heating plate 170 with a gap are provided to prevent particles or the like from being adhered to wafer W. In an example shown in FIG. 6, gap pins 173 are provided at seven sites and wafer W is supported by the provided seven gap pins 173. Gap pins 173 are configured to support wafer W with maintaining a gap (a gap height; H) corresponding to the height from the top surface of heating plate 170 to the top surface of gap pins 173. Gap height H, in such a case, for example, may be 0.1 mm to 0.3 mm Further, gap pins 173 are formed to conduct heat from the surface of heating plate 170 mainly through air in a state where wafer W is being supported by gap pins 173 with maintaining the gap as described above.

As shown in FIG. 4, a first elevating pin 180 supporting and elevating wafer W from down side is provided at the side below heating plate 170. First elevating pins 180 are movable up and down by an elevation driving mechanism 181. Through-holes 182 penetrating through heating plate 170 in thickness direction is formed in the vicinity of central portion of heating plate 170. First elevating pins 180 may move upward from downside of heating plate 170, pass through through-holes 182 and protrude upward of heating plate 170.

Heating plate accommodating unit 161 has an annular-shaped maintaining member 190 accommodating heating plate 170 and maintaining the outer periphery of the heating plate, and a substantially cylindrical-shaped support ring 191 surrounding the outer periphery of annular-shaped maintaining member 190. A ventilation port 191 a ventilating, for example, inert gas toward processing chamber S is formed on the top surface of support ring 191. The inert gas can be ventilated to purge inside of processing chamber S. Further, a cylindrical case 192 defining the outer periphery of heating plate accommodating unit 161 is provided outside support ring 191.

In cooling unit 152 adjacent to heating unit 151, there is provided, for example, a cooling plate 200 for cooling wafer W that is placed thereon. Cooling plate 200 has, for example, an approximately square plate shape as shown in FIG. 5, and the edge surface at heating plate 170 side is convexly curved outwardly in an arc shape. As shown in FIG. 4, inside cooling plate 200, a cooling member 200a such as a Peltier device is incorporated to adjust cooling plate 200 at a predetermined set temperature.

Cooling plate 200 is attached to a rail 201 extending toward heating unit 151, and travels on rail 201 by a driving unit 202, and moves up to the upper side of heating plate 170 at heating unit 151.

In cooling plate 200, two slits 203 are formed along the X direction as shown, for example, in FIG. 5. Slits 203 are formed from the edge surface of cooling plate 200 at heating unit 151 side to the vicinity of the center of cooling plate 200. By slits 203, the interference between cooling plate moved to heating unit 151 side and first elevation pins 180 protruding on heating plate 170, is prevented. As shown in FIG. 4, second elevation pins 204 are provided at the lower side of cooling plate 200 and configured to be elevated by an elevation driving unit 205. Second elevation pins 204 may rise from the lower side of cooling plate 200, pass through slits 203, and protrude to the upper side of cooling plate 200.

As shown in FIG. 5, in both of that walls of casing 150 that cooling plate 200 is placed therebetween, carrying in/out ports 210 are formed for carrying in and out wafer W.

Other post-exposure baking apparatuses 94 to 99 and 131 to 133 have the same configuration as post-exposure baking apparatus 130 as described above, and thus, description will be omitted.

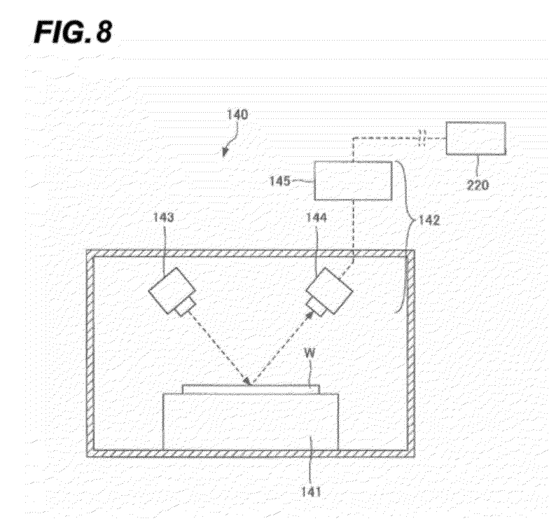

Next, a critical dimension measuring apparatus will be described referring to FIG. 8 which is a longitudinal sectional view schematically showing the configuration of the critical dimension measuring apparatus.

As shown in FIG. 8, for example, critical dimension measuring apparatus 140 includes a placing table 141 that arranges wafer W horizontally, and an optical surface profilometer 142. Placing table 141 is formed of, for example, an X-Y stage so as to move horizontally in a two-dimensional direction. Optical surface profilometer 142 includes, for example, a light irradiating unit 143, a light detecting unit 144 and a calculating unit 145. Light irradiating unit 143 irradiates light from an inclined direction with respect to wafer W. Light detecting unit 144 detects the light that is irradiated from light irradiating unit 143 and reflected from wafer W. Calculating unit 145 calculates critical dimension CD of the resist pattern on wafer W based on the light receiving information of light detecting unit 144. Critical dimension measuring apparatus 140 measures critical dimension CD of the resist pattern using, for example, a scatterometry method. When using the scatterometry method, calculating unit 145 compares the light intensity distribution in the plane of wafer W detected by light detecting unit 144 to a virtual light intensity distribution stored in advance. And, critical dimension CD of a resist pattern can be measured by obtaining critical dimension CD of the resist pattern corresponding to the virtual light intensity distribution.

In addition, critical dimension measuring apparatus 140 can measure critical dimension CD at a plurality of measuring points in the plane of wafer W by moving wafer W relatively horizontally with respect to light irradiating unit 143 and light detecting unit 144.

In coating and developing processing system 1 having above-mentioned configuration, coating and developing process is performed as follows.

First, using wafer transfer unit 22 as shown in FIG. 1, unprocessed wafer W is carried-out one by one from cassette C on cassette placing table 20, and transferred sequentially to processing station 13. Wafer W is then transferred to temperature control apparatus 70, which belongs to third processing apparatus group G3, to control the temperature to a predetermined temperature. Then, wafer W is transferred to, for example, bottom coating apparatus 43 by first transfer apparatus 30 to form an anti-reflection coating. Subsequently, wafer W is transferred to thermal processing apparatus 75 and high-precision temperature control apparatus 80 sequentially by first transfer apparatus 30 to be subjected to a predetermined processing in each processing apparatus. Wafer W is then transferred to, for example, resist coating apparatus 40 by first transfer apparatus 30.

In resist coating apparatus 40, for example, a predetermined amount of resist liquid is supplied to the rotating surface of wafer W from a nozzle. And then, the resist liquid is spread into the entire surface of wafer W to form a resist coating on wafer W.

Wafer W that has a resist coating formed thereon is transferred to, for example, pre-baking apparatus 81 by first transfer apparatus 30 to be subjected to a thermal processing (pre-bake). Then, wafer W is transferred to peripheral exposing apparatus 102 and high-precision temperature control apparatus 93 sequentially by second transfer apparatus 31 to be subjected to a predetermined processing in each processing apparatus. Wafer W is then transferred to exposing apparatus A by wafer transfer unit 111 of interface station 14. When wafer W is transferred to exposing apparatus A, a light is irradiated from a light source onto the resist coating of wafer W via a mask to expose a predetermined pattern on the resist coating. In this way, wafer W is subjected to an exposure process.

After the exposure is completed, wafer W is transferred to, for example, post-exposure baking apparatus 94 of processing station 13 by wafer transfer unit 111 of interface station 14. In post-exposure baking apparatus 94, wafer W is first carried in from carrying in/out ports 210, and is arranged on cooling plate 200 as shown in FIG. 4. Continuously, as cooling plate 200 moves, wafer W moves to the upper side of heating plate 170. Wafer W is delivered from cooling plate 200 to first elevation pins 180, and then placed on heating plate 170 by first elevation pins 180. In this way, the thermal processing (post-exposure baking) of wafer W is initiated. And, after a predetermined time is lapsed, wafer is separated from heating plate 170 by first elevation pins 180 to terminate the thermal processing of wafer W. Wafer W is then delivered from first elevation pins 180 to cooling plate 200 to be cooled, and transferred from cooling plate 200 to the outside of post-exposure baking apparatus 94 via carrying in/out port 210.

After the post-exposure baking is completed, wafer W is transferred to, for example, developing processing apparatus 50 by second transfer apparatus 31 to develop the resist coating on wafer W. Then, wafer W is transferred to post baking apparatus 85, for example, by second transfer apparatus 31 to perform a thermal processing (post bake), and then, transferred to high-precision temperature control apparatus 72 to control the temperature. Wafer W is then returned to cassette C of cassette station 12 by wafer transfer unit 22. In this way, a series of wafer processing is completed in coating and developing processing system 1.

The coating and developing process, including the thermal process performed in coating and developing processing system 1, is controlled by, for example, main body control unit 220 shown in FIG. 1. Main body control unit 220 also controls measuring of critical dimension CD of the resist pattern on wafer W by critical dimension measuring apparatus 140. Main body control unit 220 is formed of a general-purpose computer including, for example, CPU, memory and the like, and is capable of controlling the wafer processing or the critical dimension measuring by performing a program stored therein. The program in main body control unit 220 may be the one provided therein by a computer readable recording medium. Furthermore, the program for performing the thermal processing according to the exemplary embodiment as described below may be the one provided in main body control unit 220 or heater control apparatus 172 by a computer readable recording medium.

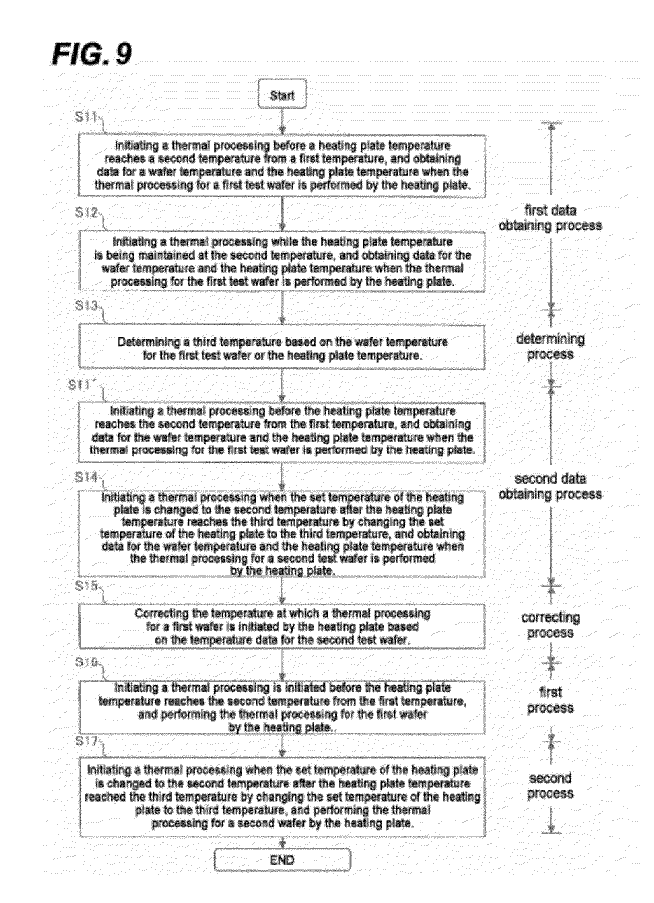

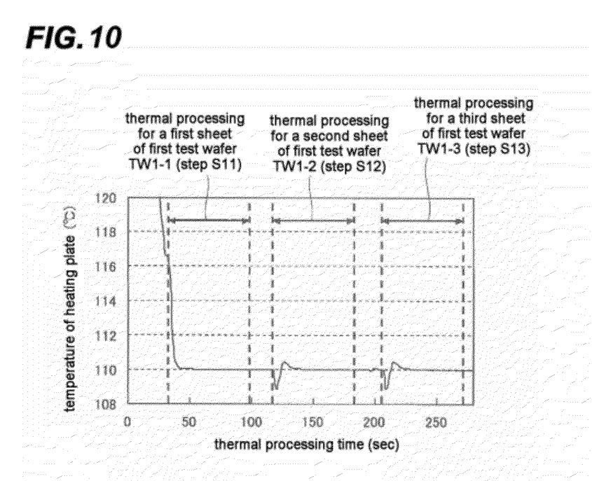

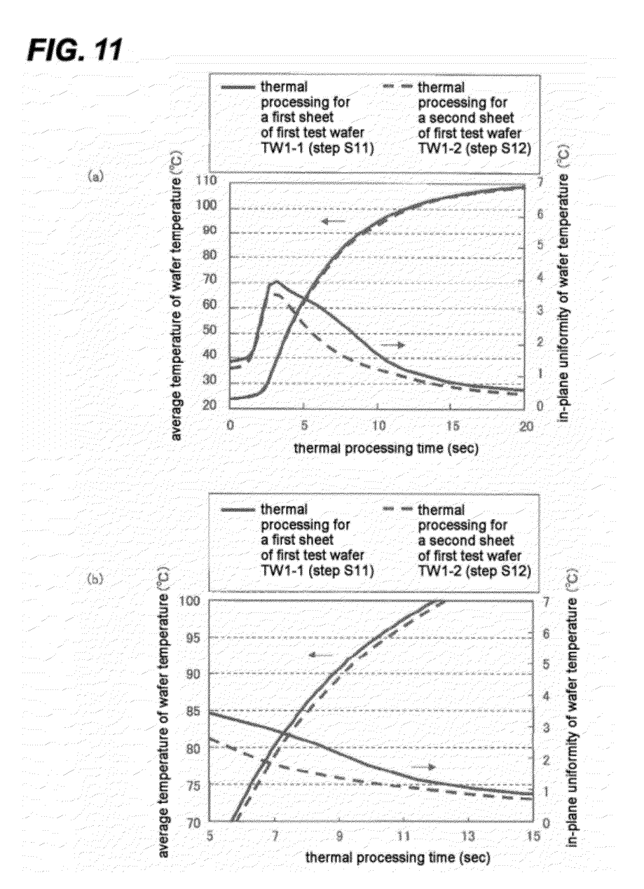

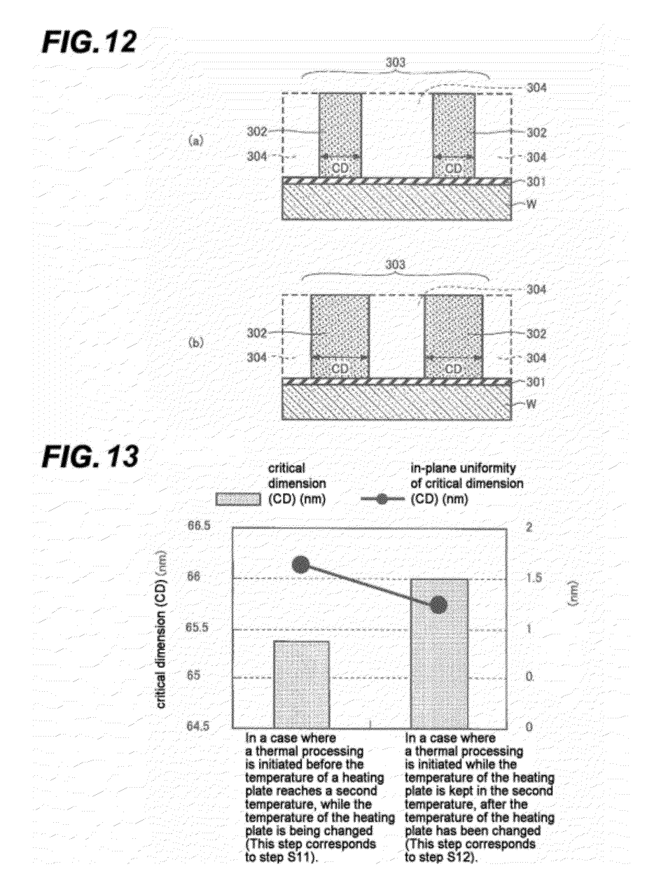

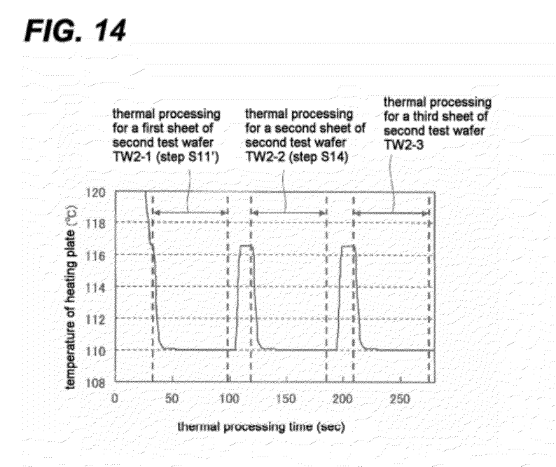

Next, with reference to FIGS. 9 to 13, the thermal processing according to the exemplary embodiment of the present disclosure will be described. FIG. 9 is a flowchart for explaining the sequence of each process of thermal processing. FIG. 10 is a graph showing the change in heating plate temperature PV over a time period at steps S11 and S12. FIGS. 11(a) and 11(b) are graphs showing the change in wafer temperature WT of test wafers TW-1 and TW-2 over a time period at steps S11 and S12. FIG. 11(b) is an enlarged view of a portion of FIG. 11(a). FIG. 12 is a cross sectional view schematically showing resist patterns formed by the post-exposure baking performed depending on the thermal processing conditions equal to each of steps S11 and S12 after the exposure process, and being subjected to the developing process. FIG. 13 is a graph showing the comparison result of critical dimension CD of the resist patterns in the case of the post-exposure baking performed depending on the thermal processing conditions equal to each of steps S11 and S12. FIG. 14 is a graph showing the change in heating plate temperature PV over a time period at steps S16 and S17.

As shown in FIG. 9, the thermal processing according to the exemplary embodiment of the present disclosure has a first data obtaining process (steps S11 and S12), a determining process (step S13), a second data obtaining process (step S14), a correcting process (step S15), a first process (step S16) and a second process (step S17).

According to the thermal processing of the exemplary embodiment of the present disclosure, the thermal processing condition of the wafer where the thermal processing is initiated after the set temperature is reached, is adjusted in a feed-forward manner so that the temperature history of the wafer becomes equal to the wafer where the thermal processing is initiated before the set temperature is reached. For that reason, the thermal processing according to the exemplary embodiment of the present disclosure includes an adjusting process that adjusts the thermal processing condition in advance, and a thermal process that actually performs the thermal processing on wafer based on the adjusted thermal processing condition. The adjusting process includes respective processes from the first data obtaining process (steps S11 and S12) to the correcting process (step S15). And, the thermal process includes a first process (step S16) and a second process (step S17).

At step S11, the set temperature of heating plate 170 is changed from a first temperature T1 to a second temperature T2, and a first test wafer TW1-1 is placed on heating plate 170 to initiate the thermal processing at the temperature higher than second temperature T2 before the temperature of heating plate 170 reaches second temperature T2 from first temperature T1 (i.e., the thermal processing is initiated at a forth temperature T4 that is the temperature initiating the thermal processing of first wafer W1 as described below). Then, using heating plate 170 for which the set temperature has been changed to second temperature T2, first test wafer TW1-1 is subjected to the thermal processing. When first test wafer TW1-1 is subjected to the thermal processing, wafer temperature WT of first test wafer TW1-1, and heating plate temperature PV are measured and recorded, and a heating plate output MV is recorded. As a result, the temperature data of wafer temperature WT of first test wafer TW1-1, the temperature data of heating plate temperature PV, and the output data of heating plate output MV are obtained. Then, after performing the thermal processing for a predetermined of time, first test wafer TW1-1 is carried-out from heating plate 170.

Wafer temperature WT may be measured by using a wafer attached with thermocouples at various portions as first test wafer TW1-1.

As described above, heater 171 is divided into a plurality of heaters 171a to 171c, and therefore, the set temperature of each of heaters 171a to 171c is changed from first temperature T1 to second temperature T2. And, before the heating plate temperature at positions P1, P2 and P3, corresponding to each of heaters 171a, 171b and 71c, respectively, reaches second temperature T2, first test wafer TW1-1 is placed on heating plate 170 to initiate the thermal processing at the temperature higher than second temperature T2 (i.e., forth temperature T4). Then, using heating plate 170 for which the set temperature has been changed to second temperature T2, first test wafer TW1-1 is subjected to the thermal processing. Wafer temperature WT of first test wafer TW1-1 at a plurality of positions P1, P2 and P3 corresponding to heaters 171a, 171b and 171c, respectively, and heating plate temperature PV that is the temperature of heating plate 170, are measured.

Temperature sensors are provided at positions P1 to P3, for example, as shown in FIG. 6 to measure heating plate temperature PV at positions P1 to P3 at an interval of a certain period of time, for example, every 1 second, and then, the measured heating plate temperatures PV are input and stored to heater control apparatus 172. Thermocouples are provided, for example, at positions corresponding to positions P1 to P3 as shown in FIG. 6 to measure wafer temperature WT at positions corresponding to positions P1 to P3 at an interval of a certain period of time, for example, every 1 second, and then, the measured wafer temperatures WT are input and stored to heater control apparatus 172.

As a set temperature of each of heaters 171a to 171c, different values of first temperature T1 and second temperature T2 may be set. As a result, uniformity of critical dimension CD in the plane of wafer W can be enhanced.

Next, at step S12, while the temperature of heating plate 170 is being maintained at second temperature T2, another first test wafer TW1-2 separate from that at step S11 is placed on heating plate 170 to initiate the thermal processing. Then, using heating plate 170, first test wafer TW1-2 is subjected to the thermal processing at second temperature T2. When first test wafer TW1-2 is subjected to the thermal processing at second temperature T2, wafer temperature WT of first test wafer TW1-2, and heating plate temperature PV are measured and recorded, and a heating plate output

MV is recorded. As a result, the data of wafer temperature WT of first test wafer TW1-2, the data of heating plate temperature PV, and the data of heating plate output MV are obtained. Then, after performing the thermal processing for a predetermined time, first test wafer TW1-2 is carried-out from heating plate 170.

An example of the data of heating plate temperature PV obtained from first data obtaining process (steps S11 and S12) is illustrated in FIG. 10. In addition, an example of the data of wafer temperature WT of first test wafers TW1-1 and TW1-2 at that time, is illustrated in FIGS. 11(a) and 11(b).

In FIGS. 11(a) and 11(b), the vertical axis in the left side represents an average of wafer temperature WT at each of positions P1, P2 and P3, and the vertical axis in the right side represents an in-plane uniformity (in-plane variation 36) of wafer temperature WT at each of positions P1, P2 and P3.

As shown in FIG. 10, at Step S11, the set temperature of heating plate 170 is changed from first temperature T1 (e.g., 140° C.) to second temperature (e.g., 110° C.). When temperature of heating plate 170 becomes 117° C. that is forth temperature T4 before heating plate temperature PV reaches second temperature T2 (e.g., 110° C.), first test wafer TW1-1 is placed on heating plate 170 to initiate the thermal processing. In doing so, heating plate temperature PV drops even after the thermal processing of first test wafer TW1-1 has been initiated, and eventually reaches second temperature T2 (e.g., 110° C.). In this case, indicated as a solid line in FIGS. 11(a) and 11(b), wafer temperature WT of first test wafer TW1-1 rises slowly from the room temperature, and reaches second temperature T2 (e.g., 110° C.).

As shown in FIG. 11(a), wafer temperature WT rises slowly, rather than instantly, to second temperature T2 from the room temperature, because the wafer has a heat capacity. That is, even though the thermal processing is initiated at forth temperature T4 higher than second temperature T2 before heating plate temperature PV reaches second temperature T2, wafer temperature WT does not rise higher than second temperature T2 as long as the wafer has a certain degree of heat capacity. However, if wafer has little heat capacity because, for example, it is very thin, and forth temperature

T4 is considerably higher than second temperature T2, wafer temperature WT may exceed second temperature T2 immediately after the thermal processing is initiated. Accordingly, forth temperature T4, that is, the temperature at which the thermal processing of first test wafer TW1-1 is initiated by heating plate 170 (i.e., the temperature at which the thermal processing of first wafer W1 is initiated), is determined depending on the heat capacity of the wafer.

At step S12, first test wafer TW1-2 is disposed and the thermal processing is initiated while heating plate temperature PV is being maintained at second temperature T2 (e.g., 110° C.), as shown in FIG. 10. By doing so, heating plate temperature PV is slightly changed after the thermal processing of first test wafer TW1-2 is initiated, then the temperature is maintained at second temperature T2 (e.g., 110° C.). At this time, wafer temperature WT of first test wafer TW1-2 is slowly increased from the room temperature and converged to second temperature T2 (e.g., 110° C.), shown as broken lines in FIGS. 11(a) and 11(b).

In FIG. 10, the temperature data of heating plate temperature PV is also represented in case that a thermal processing of a third sheet of first test wafer TW1-3 is performed based on the same condition as that for second sheet of first test wafer TW1-2, after step S12. The temperature data of heating plate temperature PV may be the same when performing the thermal processing of second sheet of first test wafer TW1-2 and third sheet of first test wafer TW1-3.

In FIG. 11(a), it appears that there is no difference in the change of heating plate temperature PV over a time period between first test wafer TW1-1 at step S11 and first test wafer TW1-2 at step S12. However, as shown in the enlarged view of FIG. 11(b), heating plate temperature PV of first test wafer TW1-1 is higher than that of first test wafer TW1-2 at the same thermal processing time over a range of temperature of 70° C. to 100 ° C. Therefore, the total heat quantity to be given to first test wafer TW1-1 becomes higher than that to be given to first test wafer TW1-2.

If the heat quantity to be given to wafer W is different, critical dimension CD of the resist pattern formed by performing a developing process as well is different. The reason is that, in the post-exposure baking (PEB), the progress of the reaction in which the resist film at the exposure area is dissolved by the developing liquid, is different, thereby the width of the soluble portion to be removed at the time of developing, is different. Herein, critical dimension CD is measured by critical dimension measuring apparatus 140.

FIGS. 12(a) and 12(b) are cross-sectional views schematically illustrating a resist pattern 303 formed by an exposing resist film 302 on wafer W formed with an anti-reflection film 301, post-exposure baking the film based on the thermal processing conditions corresponding to step S11 and step S12, respectively, after exposing, and then developing the film. FIG. 12(a) represents step S11, that is the case where the heat quantity to be given to wafer W is relatively large, and FIG. 12(b) represents step S12, that is the case where the heat quantity to be given to wafer W is relatively small. When the heat quantity to be given to wafer W becomes larger, the reaction in which resist film 302 at the exposure area is dissolved by the developing liquid to be soluble portion 304 is progressed, the width of soluble portion 304 to be removed when developing becomes larger, and critical dimension CD of resist pattern 303 to be formed becomes smaller.

Specifically, the measurement result of critical dimension CD of the resist pattern is represented in FIG. 13 where the resist pattern is formed by post-exposure baking the resist film corresponding to step S11 and step S12 after exposing, and developing the film. Critical dimension CD is smaller when the thermal processing is initiated before heating plate temperature PV reaches second temperature T2 during the change of heating plate temperature PV (when the thermal processing corresponding to step S11 is performed) as compared to the case where the thermal processing is initiated while heating plate temperature PV is maintained at second temperature T2 after the change of heating plate temperature PV is completed (when the thermal processing corresponding to step S12 is performed).

Meanwhile, if the thermal processing is initiated before heating plate temperature PV is stabilized, the in-plane temperature uniformity of wafer W is lowered at the time of initiating the thermal processing. Therefore, as shown in FIGS. 11(a) and 11(b), the in-plane variation (3σ) of wafer temperature WT for first test wafer TW1-1 becomes larger than the case of first test wafer TW1-2, and the in-plane uniformity of wafer temperature WT is lowered for first test wafer TW1-1 when initiating the thermal processing. Also, as shown in FIG. 13, the in-plane uniformity of critical dimension CD of the resist pattern formed by developing is lowered when the thermal processing is initiated before heating plate temperature PV reaches second temperature T2 during the change of heating plate temperature PV (when thermal processing corresponding to step S11 is performed) as compared to the case where the thermal processing is initiated while maintaining second temperature T2 after the change of heating plate temperature PV is completed (when the thermal processing corresponding to step S12 is performed).

Next, in the determining process (step S13), a third temperature T3 is determined based on heating plate temperature PV or wafer temperature WT of first test wafer TW1-1. Specifically, third temperature T3 is determined such that the change (temperature history) of heating plate temperature PV or wafer temperature WT of second wafer W2 at the second process (step S17) to be described below over a time period is set to be close to the change (temperature history) of heating plate temperature PV or wafer temperature WT of first test wafer TW1-1 over a time period at step S11.

In order to make the change (temperature history) of heating plate temperature PV or wafer temperature WT of second wafer W2 at second process (step S17) over a time period to be close to the change (temperature history) of heating plate temperature PV or wafer temperature WT of first test wafer TW1-1 over a time period at step S11, heating plate temperature PV may be preheated to third temperature T3 before the second process (step S17) is initiated, then the second process (step S17) may be initiated when heating plate temperature PV preheated is lowered to second temperature T2.

Third temperature T3 to be preheated may be determined based on heating plate temperature PV (fourth temperature T4) at which the thermal processing for first test wafer TW 1-1 at step S11 is initiated. For example, when wafer temperature WT and heating plate temperature PV are measured only at the center position, third temperature T3 may be the same as fourth temperature T4. Further, when wafer temperature WT and heating plate temperature PV are measured at several positions (e.g., P1, P2, P3) and in-plane distribution of wafer W is adjusted, fourth temperature

T4 may be corrected after determining third temperature T3, as described below. However, fourth temperature T4 is heating plate temperature PV at a predetermined time when heating plate 170 is naturally cooled from first temperature T1 to second temperature T2, and fourth temperature T4 may not be lowered at the predetermined time for a correction. Also, the predetermined time is set by the substrate processing and may not be adjusted. Therefore, third temperature T3 may be set to be higher than fourth temperature T4, and fourth temperature T4 may be increased when corrected.

Further, as for step 12, the thermal processing of first test wafer TW1-2 may be initiated by heating plate 170 for which the set temperature is changed to second temperature T2, when the set temperature of heating plate 170 is changed to a preliminary third temperature T3 and then changed to second temperature T2 after the temperature of heating plate 170 reaches third temperature T3. And, the temperature data of wafer temperature WT of first test wafer TW1-2 may be obtained corresponding to various third temperatures T3, by preliminary determining to different third temperatures T3 and repeating step S12 several times. In addition, in the determining process (step S13), third temperature T3 may be determined such that the temperature data of wafer temperature WT of first test wafer TW1-2 is equal to that of first test wafer TW1-1.

Next, in the second data obtaining process (step S14), the thermal processing for a second test wafer TW2 is initiated by heating plate 170 when the set temperature of heating plate 170 is changed to third temperature T3 that is higher than second temperature T2. And, second test wafer TW2 is thermally processed at second temperature T2 by heating plate 170 when the set temperature of heating plate 170 is changed to second temperature T2 after the temperature of heating plate 170 reached third temperature T3. When second test wafer TW2 is thermally processed at second temperature T2, various data are obtained such as the data of wafer temperature WT of second test wafer TW2, the data of heating plate temperature PV, and the data of heating plate output MV. After performing the thermal processing for a predetermined time, second test wafer TW2 is carried-out from heating plate 170.

Step S14 may be performed with the same condition as that of step S12, except that the set temperature of heating plate 170 is changed to third temperature T3, and then the set temperature of heating plate 170 is changed to second temperature T2 after the temperature reached third temperature T3. Therefore, step S11 may be performed again after the determining process (step S13) and right before step S14, and step S14 may be followed step S11. Herein, repeated step S11 and step S14 are regarded as the second data obtaining process, an example of the temperature data of heating plate temperature PV obtained in the second data obtaining process is represented in FIG. 14.

As shown in FIG. 14, the set temperature of heating plate 170 is changed from first temperature T1 (e.g., 140° C.) to second temperature T2 (e.g., 110° C.) at repeated step S11 (step S11′), the thermal processing is initiated by disposing a second test wafer TW2-1 on heating plate 170 at fourth temperature T4 (e.g. 117° C.) higher than second temperature T2 (e.g., 110° C.), before the temperature of heating plate 170 is reached to second temperature T2. By doing so, heating plate temperature PV is continuously lowered after the thermal processing of second test wafer TW2-1 is initiated, then reaches second temperature T2 (e.g., 110° C.). In this case, since wafer temperature WT of second test wafer TW2-1 is slowly increased from the room temperature to second temperature T2 (e.g., 110° C.), changing similarly to wafer temperature WT of first test wafer TW1-1 as shown in FIG. 11(a).

Also, as shown in FIG. 14, the set temperature of heating plate 170 is changed to third temperature T3 (e.g., 117° C.) higher than second temperature T2 (e.g., 110° C.), after repeated step S11 (step S11′) and before step S14. And, at step S14, the thermal processing is initiated by disposing a second test wafer TW2-2 when the set temperature of heating plate 170 is changed to second temperature T2 (e.g., 110° C.) after the temperature of heating plate 170 reaches third temperature T3 (e.g., 117° C.). By doing so, heating plate temperature PV is lowered after the thermal processing for second test wafer TW2-2 is initiated, then reaches second temperature T2 (e.g., 110° C.). In this case, since wafer temperature WT of second test wafer TW2-2 is slowly increased from the room temperature to second temperature T2 (e.g., 110° C.), changing similarly to wafer temperature WT of first test wafer TW1-1 as shown in FIG. 11(a).

That is, the time change (temperature history) for second test wafer TW2-1 at repeated step S11 (step S11′) and second test wafer TW2-2 at step S14 become approximately the same, and the total hat quantity given to second sheet of second test wafer TW2-2 and first sheet of second test wafer TW2-1 become approximately the same.

In FIG. 14, the temperature data of heating plate temperature PV is illustrated in a case that the thermal processing for a third sheet of second test wafer TW2-3 is performed based on the same thermal processing condition as that for second sheet of second test wafer TW2-2 after step S14. The temperature data of heating plate temperature PV when performing the thermal processing for third sheet of second test wafer TW2-3 may be the same as the temperature data of heating plate temperature PV when performing the thermal processing for second sheet of second test wafer TW2-2.

Next, in the correcting process (step S15), fourth temperature T4 is corrected based on the temperature data of second test wafer TW2-2. Fourth temperature is the temperature where the thermal processing for first wafer W1 is initiated by heating plate 170 before the temperature reaches second temperature T2 from first temperature T1.

First wafer W1 corresponds to the first substrate of the substrate group in the exemplary embodiment of the present disclosure.

When the temperature data of wafer temperature WT at step S14 is higher than the temperature data of wafer temperature WT at step S11′, and the difference therebetween is larger than a predetermined amount, following correction is possible at the correcting process (step S15). For example, instead of naturally cooling the temperature of heating plate 170 from first temperature T1 (e.g., 140° C.) to second temperature T2 (e.g., 110° C.) at the first process (step S16), fourth temperature T4 may be increased by slightly heating heating plate 170. Alternatively, when the temperature of heating plate 170 is naturally cooled from first temperature T1 (e.g., 140° C.) to second temperature T2 (e.g., 110° C.) at the first process (step S16), fourth temperature T4 may be increased by advancing the initiating timing of the thermal processing for first wafer W1.

When wafer temperature WT and heating plate temperature PV are measured only at the center position, the correcting process (step S15) may be omitted.

From the above, From the above, the adjustment of temperature condition including determining third temperature T3 and correcting fourth temperature T4 is performed by performing the correcting process (step S15) from the first data obtaining process (step S11). And then, the thermal processing for each of a plurality of wafers of the wafer group to be processed is performed.

In the first process (step S16), the set temperature of heating plate 170 is changed from first temperature T1 to second temperature T2 first, and then the thermal processing is initiated by disposing the first wafer (first wafer W1) onto heating plate 170 when the temperature of heating plate 170 reaches fourth temperature T4 corrected at the correcting process (step S15) before the temperature of heating plate 170 reaches second temperature T2. And, first wafer W1 is thermally processed by heating plate 170 of which the set temperature is changed to second temperature T2, and then, carried-out from heating plate 170 after performing the thermal processing for a predetermined of time.

Next, in the second process (step S17), the set temperature of heating plate 170 is changed to third temperature T3 first, and then the thermal processing is initiated by disposing the second wafer (next wafer W2) onto heating plate 170 when the set temperature of heating plate 170 is changed to second temperature T2 after the temperature of heating plate 170 reaches third temperature T3. And, second wafer W2 is thermally processed by heating plate 170 of which the set temperature is changed to second temperature T2, and then, carried-out from heating plate 170 after performing the thermal processing for a predetermined of time.

Second wafer W2 corresponds to the next substrate of the substrate group in the exemplary embodiment of the present disclosure.

According to the exemplary embodiment of the present disclosure, the thermal processing of the first wafer (initial wafer W1) is initiated when the temperature of heating plate 170 is fourth temperature T4, before the temperature of heating plate 170 reaches second temperature T2 from first temperature T1. Therefore, the thermal processing for first wafer (first wafer W1) can be initiated faster than the case where the thermal processing is initiated after the temperature of heating plate 170 reaches second temperature T2.

For example, when first temperature T1, second temperature T2 and third temperature T3 are set to 140° C., 110° C., and 117° C., respectively, the thermal processing of the first wafer (first wafer W1) is initiated faster by about 30 sec.

Also, according to the exemplary embodiment of the present disclosure, the change (temperature history) of wafer temperature WT of the first wafer (first wafer W1) over a time period at the first process (step S16) may be the same as the change (temperature history) of wafer temperature WT of the second wafer (next wafer W2) over a time period at the second process (step S17). Therefore, the progress of the reaction where the resist film is dissolved at the exposure area by the developing liquid can be the same in the first and second processes thereby the widths of the soluble portion to be removed at the developing process can be made the same. Therefore, critical dimensions CDs of the resist patterns formed by the developing process among the first wafer (first wafer W1) and the second wafer (next wafer W2) (and following wafer W) can be approximately the same.

Further, according to the exemplary embodiment of the present disclosure, heating plate 170 needs not be made thinner to lower the heat capacity which tends to decrease the hardness of heating plate 170. Further, since the cooling mechanism that cools heating plate 170 is not necessary, there is no concern that the cost for the apparatus increases.

The present disclosure may be applied not only to the post-exposure baking apparatus, but also to various thermal processing apparatuses. Further, the present disclosure may be applied to an apparatus that performs a thermal processing for the semiconductor substrate, glass substrate, and other various substrates.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A method of a thermal processing in which each of a plurality of substrates of a substrate group is sequentially disposed and processed on a heating plate set to a predetermined temperature, the method comprising:
a first process comprising:
changing a set temperature of the heating plate from a first temperature to a second temperature which is lower than the first temperature;
initiating a thermal processing for a first substrate of the substrate group before the temperature of the heating plate reaches the second temperature; and
continuing the thermal processing for the first substrate by the heating plate while the temperature of the heating plate is being maintained at the second temperature; and
a second process comprising:
changing the set temperature of the heating plate from the second temperature to a third temperature which is higher than the second temperature, after the first process for the first substrate is completed;
initiating a thermal processing for a second substrate of the substrate group which is a next substrate to the first substrate in the substrate group when the set temperature of the heating plate is changed to the second temperature, after the temperature of the heating plate reached the third temperature; and
continuing the thermal processing for the second substrate by the heating plate while the temperature of the heating plate is being maintained at the second temperature.

2. The method of claim 1, further comprising:
a first data obtaining process comprising:
changing the set temperature of the heating plate from the first temperature to the second temperature;
initiating a thermal processing for a first test substrate before the temperature of the heating plate reaches the second temperature; and
obtaining temperature data for the first test substrate or the heating plate while the thermal processing is being performed for the first test substrate; and
determining the third temperature based on the temperature data for the first test substrate or the heating plate.

3. The method of claim 2, wherein the determining determines the third temperature to be higher than the temperature at which the thermal processing for the first substrate is initiated.

4. The method claim 3, further comprising:
a second data obtaining process comprising:
changing the set temperature of the heating plate to the third temperature after determining the third temperature;
initiating a thermal processing for a second test substrate by the heating plate when the set temperature of the heating plate is changed to the second temperature, after the temperature of the heating plate reached the third temperature; and
obtaining temperature data for the second test substrate while the thermal processing is being performed for the second test substrate; and
correcting the temperature at which the thermal processing for the first substrate is initiated based on the temperature data for the second test substrate.

5. The method of claim 1, wherein the temperature at which the thermal processing for the first substrate by the heating plate is initiated is determined based on a heat capacity of the first substrate.

6. A non-transitory computer-readable recording medium storing a computer executable program that, when executed, causes a computer to perform the method of the thermal processing of claim 1.

7. A thermal processing apparatus comprising:
a heating plate configured to be set to a predetermined temperature and dispose each of substrates of a substrate group including a plurality of substrates thereby sequentially performing a thermal processing for the plurality of substrates; and
a control unit configured to control an overall operation of the thermal processing apparatus,
wherein the control unit changes a set temperature of the heating plate from a first temperature to a second temperature which is lower than the first temperature, initiates a thermal processing for a first substrate of the substrate group before the temperature of the heating plate reaches the second temperature, continues the thermal processing for the first substrate by the heating plate while the temperature of the heating plate is being maintained at the second temperature, changes the set temperature of the heating plate from the second temperature to a third temperature which is higher than the second temperature after the thermal processing for the first substrate is completed, initiates a thermal processing for a second substrate of the substrate group which is a next substrate to the first substrate in the substrate group when the set temperature of the heating plate is changed to the second temperature after the temperature of the heating plate reached the third temperature, and continues the thermal processing for the second substrate by the heating plate while the temperature of the heating plate is being maintained at the second temperature.

8. The thermal processing apparatus of claim 7,
wherein the control unit changes the set temperature of the heating plate from the first temperature to the second temperature, initiates a thermal processing for a first test substrate before the temperature of the heating plate reaches the second temperature, obtains temperature data for the first test substrate or the heating plate while the thermal processing is being performed for the first test substrate, and determines the third temperature based on the temperature data for the first test substrate or the heating plate.

9. The thermal processing apparatus of claim 8, wherein the control unit determines the third temperature to be higher than the temperature at which the thermal processing for the first substrate by the heating plate is initiated.

10. The thermal processing apparatus of claim 9,
wherein the control unit changes the set temperature of the heating plate to the third temperature after determining the third temperature, initiates a thermal processing for a second test substrate by the heating plate when the set temperature of the heating plate is changed to the second temperature after the temperature of the heating plate reached the third temperature, obtains temperature data for the second test substrate while the thermal processing is being performed for the second test substrate, and corrects the temperature at which the thermal processing for the first substrate is initiated based on the temperature data for the second test substrate.

11. The thermal processing apparatus of claim 7, wherein the temperature at which the thermal processing for the first substrate by the heating plate is initiated is determined based on a heat capacity of the first substrate.

12. A non-transitory computer-readable recording medium storing a computer executable program that, when executed, causes a computer to perform the method of the thermal processing of claim 5.
